(19) United States
(12) Patent Application Publication
(10) Pub. No.: US 2004/0036909 A1
(43) Pub. Date: Feb. 26, 2004

(54) Image forming apparatus conducting image formation of plural jobs in parallel

(75) Inventors: Utami Soma, Tokyo (JP); Kazuyoshi Ottomo, Tokyo (JP); Hiroshi Yamazaki, Tokyo (JP); Makoto Takeda, Tokyo (JP); Masaki Shimada, Tokyo (JP); Kunio Shijo, Chigasaki-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/641,361

(22) Filed: Aug. 13, 2003

(30) Foreign Application Priority Data
Aug. 26, 2002 (JP) JP2002-245015

(51) Int. Cl. B41F 1/00; G06F 15/00

(52) U.S. Cl. 358/1.15; 358/1.13

(57) ABSTRACT

An image forming apparatus includes: an image data storing device for storing an image date; an image data generating device for taking up image data from a plurality of image data sources and generating memory image data to write to the image data storing device; a writing image data generating device for generating writing image data by processing image data which have been read out from the image data storing device; an image forming device for forming an image onto a recording sheet; and a controller for controlling an entire image forming apparatus. The controller controls the writing image data generating device and the image forming device to conduct a parallel processing which forms images for a plurality of jobs in parallel.

### BACKGROUND OF THE INVENTION

The present invention relates to an image forming apparatus, and particularly to the execution control technology for multiple jobs in an image forming apparatus as a multifunctional machine having at least two of the copying function, facsimile function and printing function.

The following proposals have been made for the control of ensuring an effective operation of a multifunctional machine:

A multifunctional machine is disclosed in the Japanese Patent Laid-Open No. Hei 06-152821, where memory means is provided to memorize a default value for specifying image forming conditions, and the memorized default value is called out to set the default mode by a simple operation.

Another multifunctional machine is disclosed in the Japanese Application Patent Laid-open Publication No. Hei 08-123970, where priority designation means is provided to designate the priority in the execution of multiple jobs and to permit use of a desired one of the copying, printing and facsimile functions on a priority basis.

The Japanese Application Patent Laid-open Publication No. Hei 09-163061 discloses an image forming processing control method for parallel processing of various processing such as image reading, image formation, facsimile transmission and reception, and network transmission and reception (transmission and reception via the computer network) in a multifunctional machine.

The Japanese Application Patent Laid-open Publication No. 2001-24826 discloses a control method for saving the capacity of memory means for storing image information by transferring to a host computer the image information on the request for execution of one job during execution of the other.

In the prior art control of a multifunctional machine including the above-mentioned examples, simultaneous parallel processing of image data reception and image formation, for example, has been carried out, but simultaneous execution of image formation of multiple jobs has not been executed.

This is because the multifunctional machine has only one image forming means, and parallel execution of multiple jobs by one image forming means has been considered difficult.

In various forms of processing in a multifunctional machine, however, processing of image formation on a recording material takes the longest time. It often happens that processing of image formation continues even after completion of other processing.

In the following cases, a user often has to wait for a long time. This has made the user feel inconvenient and inefficient, and work efficiency is actually poor in every respect.

(1) When one through three sheets are to be copied during the processing of reception of a full-length text through a facsimile machine, processing of copying does not start until completion of the reception by the facsimile machine.

(2) When one through three sheets are to be copied during printing on reception of full-length text via the network, processing of copying does not start until completion of printing.

(3) When one through three sheets are to be copied during copying of a large volume of sheets, printing does not start until completion of copying.

The object of the present invention is to solve the above-mentioned problems with a multifunctional machine and to provide an image forming apparatus as a multifunctional machine for high-efficiency execution of multiple jobs, without causing a user feel inconvenient and inefficient.

The above-mentioned object of the present invention can be achieved by any one of the following Structures 1 through 8.

1. An image forming apparatus comprising: an image data memory means for storing image data; memory image data generation means for generating memory image data to be written into the above-mentioned image data memory means by capturing and processing image data from multiple image data sources; writing image data generation means for generating writing image data by processing the image data read from the above-mentioned image data memory means; image forming means for forming an image on a recording material; and control means for controlling the entire system. This image forming apparatus is characterized by controlling the above-mentioned writing image data generation means and image forming means, thereby allowing parallel image formation of multiple jobs.

2. An image forming apparatus according to Structure 1 further comprising image reading means, wherein the memory image data generation means processes the image data generated by the image reading means, and generates the memory image data.

3. An image forming apparatus according to Structure 1 or 2, wherein the memory image data generation means processes the image data received by facsimile communications via a telephone line, and generates the above-mentioned memory image data.

4. An image forming apparatus according to any one of the Structure 1, 2 and 3, wherein the memory image data generation means processes the image data received via the computer network, and generates the memory image data.

5. An image forming apparatus according to any one of the Structure 1, 2, 3 and 4 further comprising multiple ejecting sections, wherein the above-mentioned control means selects the destination of ejected paper in the ejecting means in such a way that the recording materials produced by the above-mentioned parallel processing are sorted for each job and ejected.

6. An image forming apparatus according to any one of the Structure 1, 2, 3, 4 and 5 wherein the control means further comprises a decision means that determines that the above-mentioned parallel processing is not carried out under a predetermined image forming condition.

7. An image forming apparatus according to Structure 6, wherein the above-mentioned predetermined image forming condition is a predetermined finishing condition.

8. An image forming apparatus according to Structure 6 or 7, wherein the above-mentioned predetermined image forming condition is the number of recording sheets to be produced in one job.

### BRIEF DESCRIPTION OF THE DRAWINGS

FIG. 1 is a drawing representing an image forming system including the image forming apparatus as an embodiment of the present invention.

FIG. 2 is a functional block diagram of an image forming apparatus as an embodiment of the present invention.

FIG. 3 is a flowchart for a prior art job control.

FIG. 4 is a flowchart for a prior art job control.

FIG. 5 is a flowchart for job control according to the present invention.

FIG. 6 is a flowchart representing the decision for and against parallel execution of image outputting.

FIG. 7 is a flowchart for job control according to the present invention.

### DETAILED DESCRIPTION OF THE PREFERRED EMBODIMENT

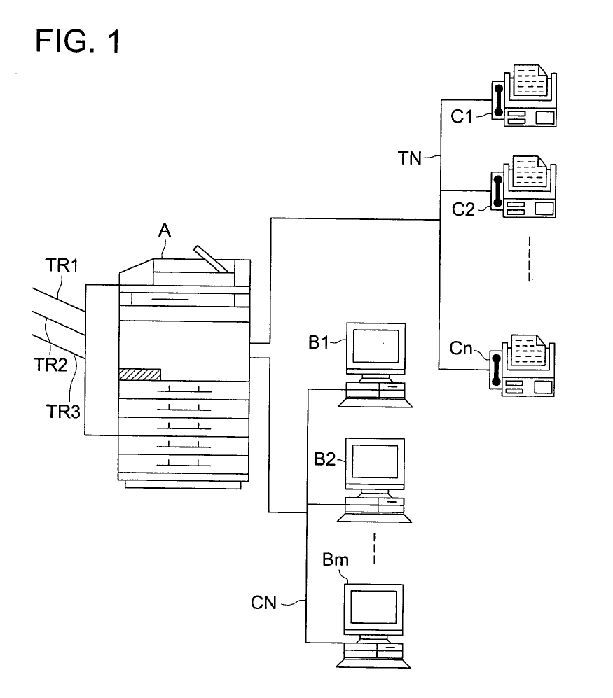

FIG. 1 is a drawing representing an image forming system including the image forming apparatus relating to an embodiment of the present invention.

In the drawing, a symbol A denotes an image forming apparatus as a multifunctional machine having at least two of copying function, printer function and facsimile function. Symbols B1, B2, . . . Bm represent image data output apparatuses such as a personal computer and workstation, and Symbols C1, C2, . . . Cn show facsimile apparatuses. The image forming apparatus A and image data output apparatuses B1, B2, . . . Bm are connected with each other via a computer network CN, and the image forming apparatus A and facsimile apparatuses C1, C2, . . . Cn are connected with each other via a telephone line TN.

The image forming apparatus A has three ejection trays TR1, TR2 and TR3 as plural ejection sections. For example, the output of copy processing is ejected to the ejection tray TR1, the output of print processing is ejected to the ejection tray TR2, and the output of facsimile reception is ejected to the ejection tray TR3.

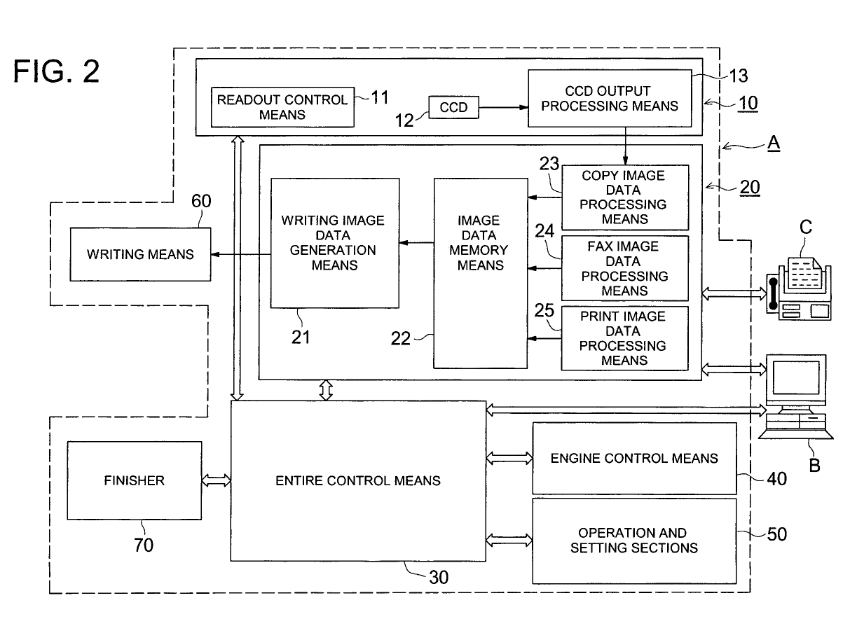

FIG. 2 is a functional block diagram of an image forming apparatus relating to an embodiment of the present invention.

In the drawing, the portion given in a dotted line indicates the image forming apparatus A as a multifunctional machine. It is connected to an image data outputting apparatus B such as a personal computer, and to a facsimile apparatus C.

Numeral 10 indicates image readout means, which contains; readout control means 11 that provides scanning operation for scanning a document and document size detection; CCD 12 for reading an image; and CCD output processing means 13 for processing analog-to-digital conversion, shading correction and area control for the output of CCD 12. The image readout means provides automatic reading of multiple documents to generate image data.

Numeral 20 denotes an image processing section, which contains writing image data generation means 21, image data memory means 22 and copy image data processing means 23. The writing image data generation means 21 provides the image data read from the image data memory means 22, with screen processing, i.e. γ correction in print processing and crosshatching on gray scale image. It generates the writing data that is synchronously controlled and LD-controlled to provide forced control so as to correspond to laser diode. The image data memory means 22 is memory means having a hard disk memory as a mass storage memory. It provides image data with error diffusion processing, inclination correction processing for correcting inclination of an image, page-sequential control processing, and compression and expansion processing, whereby the image data is memorized and the memory image data is read out.

Numeral 23 indicates a copy image data processing means. It provides spatial filtering, scaling and γ-conversion to the image data generated by the image reading means 10, and generates stored data. Numeral 24 is a fax image data processing means, which provides modem control and expands facsimile-received image data to generate the memory image data. Numeral 25 is a print image data processing means, which provides NIC control with computer network and rasterization of converting the received image data into image data for printer output, thereby generating memory image data. The copy image data processing means 23, the fax image data processing means 24 and the print image data processing means 25 constitute a memory image data generation means.

Numeral 30 denotes an entire control means for controlling the image forming apparatus A. It provides control of an engine as an image forming means, control of the image reading means 10, control of communications with image processing section 20, control of communications with the operation and setting sections 50 and control of the start and end of a job.

Numeral 40 denotes an engine control means for controlling the engine as image forming means. It provides control of paper supply, in particular, control of the selection of the recording material size, control of image formation process, and control of fixing. Numeral 50 denotes operation and setting sections, which control facsimile transmission such as job status display and setting of the transmission destination, and set various types of image forming conditions. Numeral 60 denotes a writing means having a laser diode as a light source for writing. Numeral 70 is a finisher, which provides such post-processing as selection of ejection trays TR1, TR2 and TR3 (all shown in FIG. 1) for each job type, punching, stapling and folding.

In copy processing, after being subjected to image processing such as spatial filtering in the copy image data processing means 23, the image data generated by the image reading means 10 is stored in the image data memory means 22. Then it is read and is processed into the writing data for driving the writing means 60 in the writing image data generation means 21. In the writing means 60, modulation of a laser diode is carried out according to the writing data and an image is written.

In the processing of facsimile reception, the image data received through the telephone line is processed in the fax image data processing means 24 and is stored in the image data memory means 22. Through the same processing as that in the preceding step, the image is written.

In print processing, the image data converted into the printer output data in the print image data processing means 25 is stored in the image data memory means 22. The image data read from the image data memory means 22 is subjected to γ correction and screening in the writing image data generation means 21, and is supplied to the writing means 60.

In the present embodiment, in addition to the processing of image formation carried out on a predetermined priority basis in response to a request for processing of multiple jobs, processing of image formation is carried out wherein the processing of image formation being executed is interrupted according to the decision made by the decision function of the control means 30.

The following shows some of the examples of parallel processing caused by such automatic interrupt in the present embodiment. Incidentally, the term “parallel processing” used in the present context is defined as execution of image output for a second job during the image output for a first job, i.e. during formation of an image on a recording material, without waiting for the completion of image output for the first one. The priority of the times of terminating the image outputs for two jobs in parallel processing is not predetermined. As will be discussed later, the image output for the interrupting job completes earlier since the interrupting job has a smaller amount of image in many cases.

If an interrupt of copying one through three sheets has occurred in the operation and setting sections 50 during the processing of facsimile reception of large amounts of image data, copying operation is carried out between the pages of the images to be output through facsimile reception. Upon completion of copying, processing of facsimile reception is resumed. Similarly, if there is a request for printing of a few sheets during processing of large amounts of image data, print processing is allowed to interrupt in the middle of copying. Upon completion of printing, copying is resumed.

Automatic interruption among multiple jobs can be performed among the jobs of the same type, for example, among multiple processes of copying. Further, multiple jobs can interrupt one after another during execution of one job.

In the following description, the above-mentioned parallel processing of jobs by automatic interrupt function is termed “job control according to the present invention”, and execution of jobs according to the order of reception or a predetermined priority order is termed “prior art job control”.

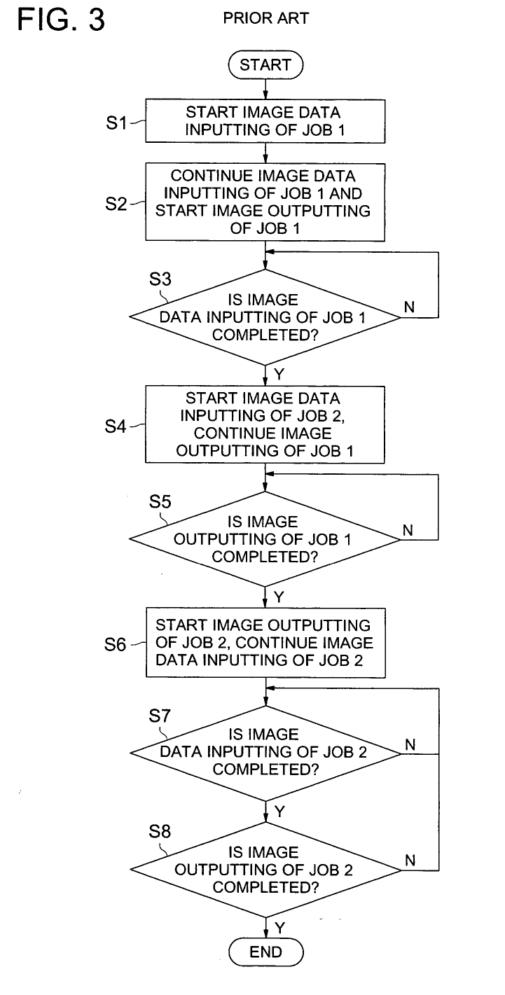

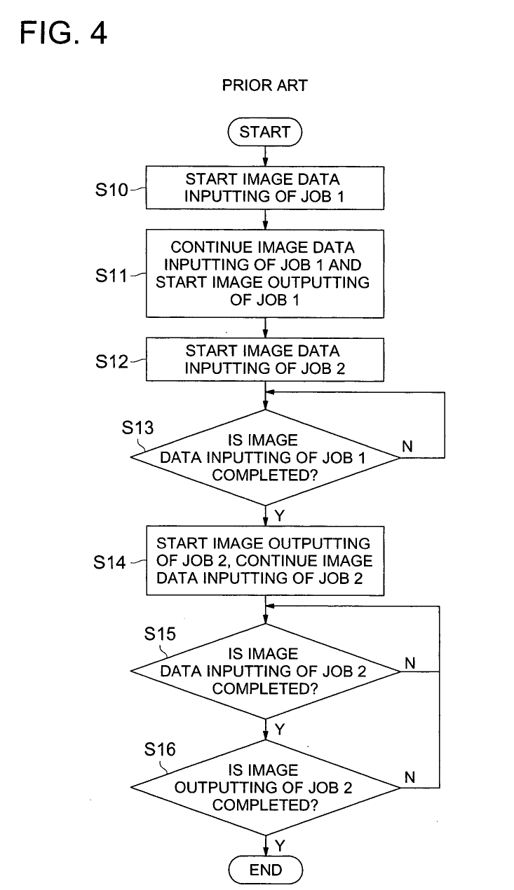

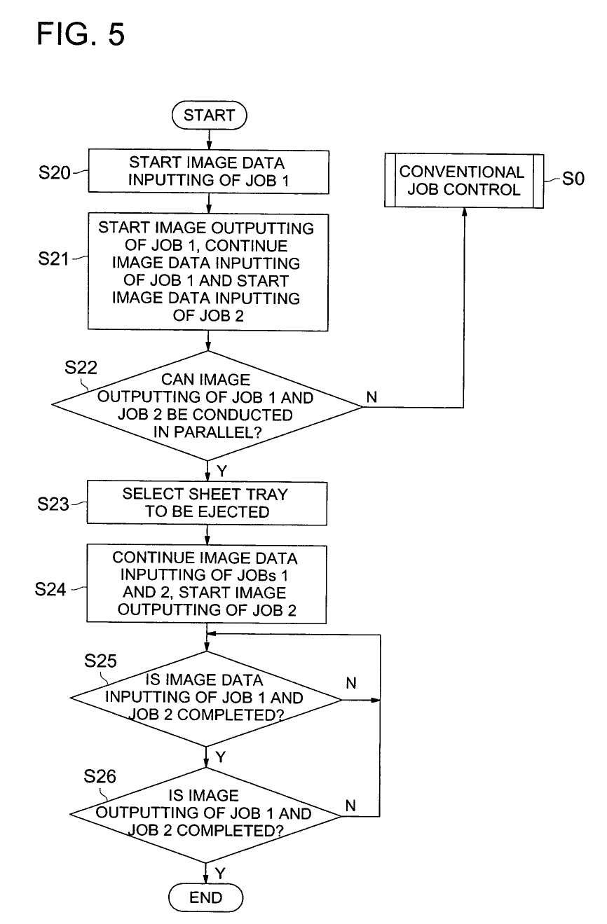

FIGS. 3 through 7 show the job control performed by the control means 30 when two jobs are executed. FIGS. 3 and 4 show prior art job control, while FIGS. 5 through 7 indicate the job control according to the present invention.

In FIG. 3, image data inputting of job 1 starts (S1). While image data inputting of job 1 continues, image outputting of job 1 starts (S2). Here image data inputting is defined as the processing of storing image data into the image data memory means 22. Image outputting is defined as reading the image data from the image data memory means 22 and recording it on the recording material.

Upon completion of the image data inputting of job 1 (Y of S3), image data inputting of job 2 starts. If image outputting of job 1 has not completed when image data inputting of job 2 has started, the image outputting of job 1 continues (S4). Upon completion of image outputting of job 1 (Y of S5), image outputting of job 2 starts (S6). In this case, image data inputting of job 2 continues (S6). Processing continues until image data inputting of job 2 and image outputting of job 2 complete (S7, S8).

FIG. 4 indicates the prior art job control when two different jobs are executed.

Image data inputting of job 1 starts (S10). While image data inputting of job 1 continues, image outputting of job 1 starts (S11). When the image data of job 2 has been received, image data inputting of job 2 starts during image data inputting of job 1, so image data inputting of jobs 1 and 2 is executed in parallel (S12) Upon completion of image outputting of job 1 (Y of S13), image outputting of job 2 of starts (S14). In this case, image data inputting of job 2 continues (S14). Processing continues until image data inputting of job 2 and image outputting of job 2 complete (S15, S16).

FIG. 5 is a flowchart for job control according to the present invention when there is a request for execution of two jobs of different types, for example, processing of facsimile reception and copying.

Image data inputting of job 1 starts (S20). Then image outputting of job 1 starts (S21). While image data inputting of job 1 continues, image data inputting of job 2 starts in step 21. Image data inputting of jobs 1 and 2 is carried out in parallel.

In step S22, the decision function of the control means 30 determines whether or not image outputting of job 2 is to be made in parallel during execution of image outputting of job 1.

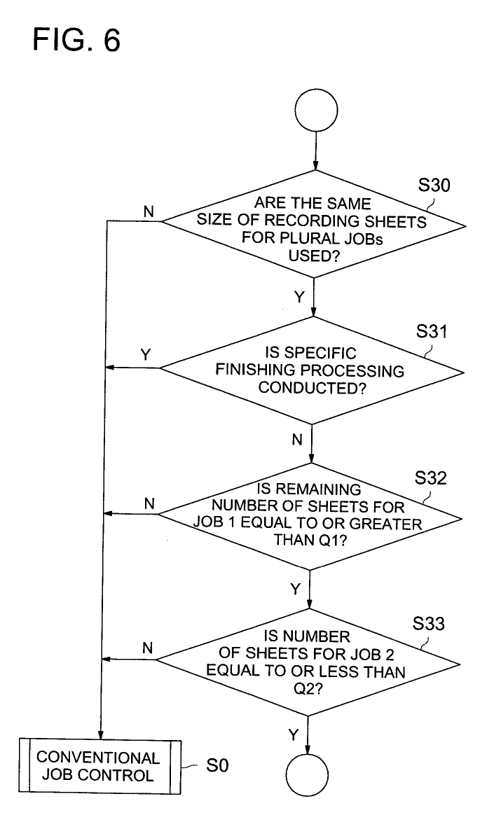

Decision whether or not parallel image outputting of jobs 1 and 2 can be executed, is carried out according to the flowchart of FIG. 6.

If the size of the recording material where the image of job 1 is output is the same as that of the recording material where the image of job 2 is output, parallel processing is performed (Y of S30). If they are different from each other, control mode returns to the prior art job control S0 shown in FIG. 4. If such specific processing as punching, stapling and folding is to be performed in the finisher 70, then control mode shifts to the prior art job control S0 shown in FIG. 4 (Y of S31). Otherwise, parallel processing is performed. If the number of remaining sheets to be executed in job 1 is equal to or greater than Q1 (e.g. number of sheets requiring 3 minutes or more), then control mode shifts to parallel processing as job control according to the present invention (Y of S32). Otherwise, the control mode shifts to the prior art job control S0. In other words, when it is estimated that there is a small number of remaining sheets in job 1 and there is little waiting time for execution of job 2, then image outputting of job 2 is carried out after completion of the image outputting of job 1, according to the prior art job control. If it is estimated that there is a great number of remaining sheets in job 1 and there is much waiting time, then control is carried out to process parallel image outputting, whereby a decision is made in step S32 to minimize the waiting time and to improve work efficiency.

If the image data inputting of job 1 has been completed and the number of remaining sheets is clear at the time of making a decision, the decision on whether there is a large number of remaining sheets or a small number of them in job 1 is made according to the known number of sheets. If the image data inputting of job 1 has not been completed at the time of making a decision, then a decision is made on the assumption that the number of remaining sheets is equal to or greater than a specified number of sheets, Q1.

If the number of sheets set in job 2 does not exceed a specified number of sheets, Q2 (e.g. 10 sheets), the control mode is switched to parallel processing (Y of S33). Otherwise, the control mode is changed to the prior art job control mode S0. If it is estimated that the image outputting of job 1 is considerably delayed by the interrupt image outputting of job 2, image is output according to the prior art job control S0, without parallel processing. If it is estimated that the image outputting of job 1 is not considerably delayed even if the interrupt outputting of job 2 has been carried out, then parallel processing is carried out by the interrupt image outputting of job 2. Similarly to that in step S32, decision in step S33 is made according to the known number of sheets if the image data inputting of job 2 has been completed and the number of remaining sheets for image formation is clear at the time of making a decision. If the image data inputting of job 2 has not been completed at the time of making a decision, then a decision is made on the assumption that the number of sheets is greater than a specified number of sheets, Q2.

The specified numbers of sheets, Q1 and Q2, determine the degree of comfort felt by a user at the time of operation. So it is preferred that these values be set according to the user's experience, and can be changed as required.

When parallel processing has been determined in step S22 of FIG. 5 (Y of S22), the destination of paper ejection is determined in step S23. When recording material is ejected into an ejection tray TR1 of FIG. 1 in image outputting of job 1, the destination of paper ejected in job 1 is arranged to be different from that in job 2 to ensure that the ejected paper in image outputting of job 2 will be ejected to the ejection tray TR2.

In step 24, image inputting of job 2 continues and image outputting of job 2 continues starts, thus, image outputting of job 1 and image outputting of job 2 are performed in parallel. In the parallel processing of image outputting, parallel outputting can be performed by alternate outputting of the images of jobs 1 and 2 for each page. It is also possible to suspend the image outputting of job 1 to perform image outputting of job 2 and to restart image outputting of job 1 upon completion thereof.

In the parallel processing as described above, paper ejection control is carried out in such a way that the output in job 1 is ejected into the ejection tray TR1 and that in job 2 into the ejection tray TR2. Accordingly, there is no confusion in the processing of image output by parallel processing.

Job control completes upon completion of the image data inputting of jobs 1 and 2 and completion of image outputting (S25 and S26).

Job control shown in FIG. 5 refers to the case of parallel processing of different jobs, e.g. the job 1 is facsimile reception, while job 2 is copying service. Parallel processing is also possible for the same type of jobs.

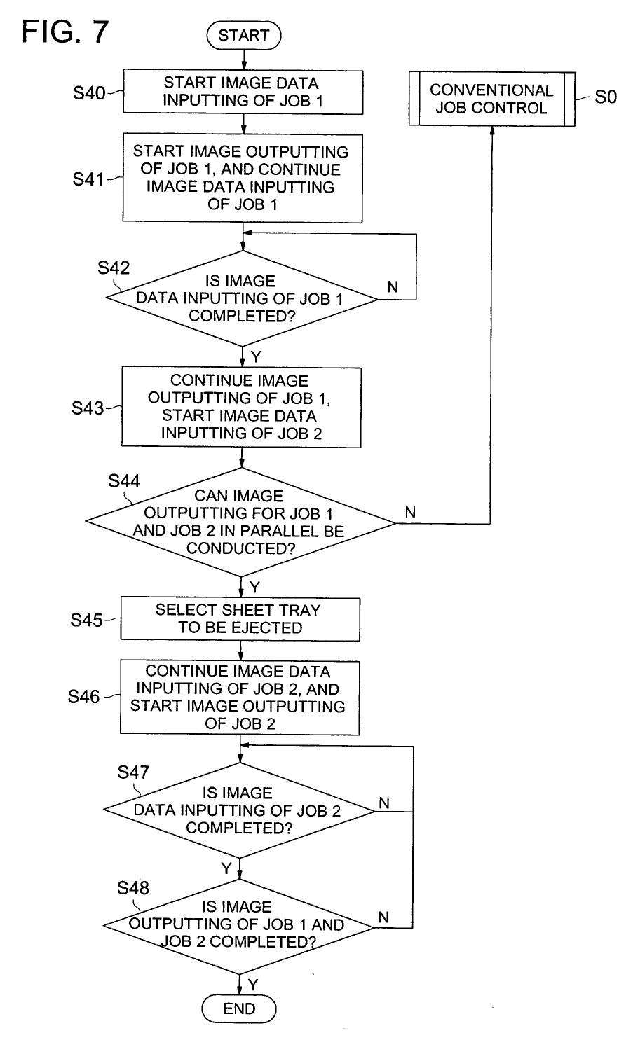

FIG. 7 is a flowchart representing the parallel control for the same type of jobs. Image data inputting of job 1 starts (S40), and then image outputting of job 1 continues and image outputting starts (S41).

Upon completion of image data inputting of job 1 (Y of S42), image outputting of job 1 continues, and the image data inputting of job 2 starts (S43).

Then a decision is made for or against parallel processing of the image outputting of job 1 and that of job 2 (S44).

Decision whether or not parallel image outputting of jobs 1 and 2 can be executed, is made according to the flowchart of FIG. 6.

If the size of the recording material where the image of job 1 is output is the same as that of the recording material where the image of job 2 is output, parallel processing is carried out (Y of S30). If they are different from each other, control mode shifts to the prior art job control S0 as shown in FIG. 3. If such specific processing as punching, stapling and folding is to be performed in the finisher 70, then control mode shifts to the prior art job control S0 shown in FIG. 3 (Y of S31). Otherwise, parallel processing is performed. If the number of remaining sheets to be executed in job 1 is equal to or greater than a specified number of sheets Q1 (e.g. number of sheets requiring 3 minutes or more), then control mode shifts to parallel processing as job control according to the present invention (Y of S32). Otherwise, the control mode shifts to the prior art job control S0. In other words, when it is estimated that there is a small number of remaining sheets in job 1 and there is little waiting time for execution of job 2, then image outputting of job 2 is carried out after completion of the image outputting of job 1, according to the prior art job control. If it is estimated that there is a great number of remaining sheets in job 1 and there is much waiting time, parallel output control is carried out, whereby a decision is made in step S32 to minimize the waiting time and to improve work efficiency.

For decision on the same type of jobs, image data inputting of job 1 has been completed and the number of remaining sheets is clear. So a decision is made according to the known number of remaining sheets.

If the number of sheets to be set in job 2 is equal to or less than a specified number of sheets Q2 (e.g. 10 sheets), the control mode is switched to parallel processing (Y of S33). Otherwise, the control mode is changed to the prior art job control mode S0. If it is estimated that the image outputting of job 1 is considerably delayed by the interrupt image outputting of job 2, image is output according to the prior art job control S0, without parallel processing. If it is estimated that the image outputting of job 1 is not considerably delayed even if the interrupt outputting of job 2 has been carried out, then parallel processing according to the present invention is carried out by the interrupt image outputting of job 2. A decision in step S33 is made according to the known number of sheets if the image data inputting of job 2 has been completed and the number of remaining sheets for image formation is clear at the time of making a decision. If the image data inputting of job 2 has not been completed at the time of making a decision, then a decision is made on the assumption that the number of sheets is greater than a specified number of sheets, Q2.

When parallel processing has been determined in step S44 of FIG. 7, the destination of paper ejection is determined in step S45. When recording material is ejected into an ejection tray TR1 of FIG. 1 in image outputting of job 1, the destination of paper ejected in job 1 is arranged to be different from that in job 2 to ensure that the ejected paper in image outputting of job 2 will be ejected to the ejection tray TR2.

In step S46, image inputting of job 2 continues and image outputting of job 2 continues starts, thus, image outputting of job 1 and image outputting of job 2 are performed in parallel. As described above, parallel outputting can be performed by alternate outputting of the images of jobs 1 and 2 for each page. It is also possible to suspend the image outputting of job 1 to perform image outputting of job 2 and to restart image outputting of job 1 upon completion thereof.

In the step parallel processing, paper ejection control is carried out in such a way that the output in job 1 is ejected into the ejection tray TR1 and that in job 2 into the ejection tray TR2.

Job control completes upon completion of the image data inputting of job 2 and completion of image outputting (S47 and S48).

According to Structures 1 through 4, priority is automatically given to the execution of the job that can be processed in a shorter time. This eliminates the possibility that the job that requires small-volume image outputting is postponed in favor of the job that requires large-volume image outputting when there is a request for processing multiple jobs, with the result that image forming efficiency is improved to the satisfaction of the user.

Structure 5 ensures that outputs are organized for each job in parallel processing of multiple jobs, whereby possible confusion in parallel processing is eliminated.

To solve the problems of possible confusion in parallel processing or small advantages of parallel processing, Structures 6 through 8 allow processing to be carried out according to the order of request or priority, whereby an easy-to-use image forming apparatus can be realized.

What is claimed is:

1. An image forming apparatus comprising:
(a) an image data storing device for storing an image data;
(b) an image data generating device for taking up image data from a plurality of image data sources and generating memory image data to write to the image data storing device;
(c) a writing image data generating device for generating writing image data by processing image data which have been read out from the image data storing device;
(d) an image forming device for forming an image onto a recording sheet; and
(e) a controller for controlling an entire image forming apparatus,
wherein the controller controls the writing image data generating device and the image forming device to conduct a parallel processing which forms images for a plurality of jobs in parallel.

2. The image forming apparatus of claim 1, further comprising an image reading device, wherein the image data generating device generates the memory image data by processing the image data generated by the image reading device.

3. The image forming apparatus of claim 1, wherein the image data generating device generates the memory image data by processing image data received by a facsimile communication through a telephone circuit.

4. The image forming apparatus of claim 1, wherein the image data generating device generates the memory image data by processing image data received through a computer network.

5. The image forming apparatus of claim 1, further comprising a plurality of sheet ejection sections, wherein the controller selects the sheet ejection sections to be ejected so that recording sheets processed in parallel are sorted for each job.

6. The image forming apparatus of claim 1, wherein the controller comprises a judging device for judging that the parallel processing is not carried out in a prescribed image forming condition.

7. The image forming apparatus of claim 6, wherein the prescribed image forming condition is a prescribed finishing condition.

8. The image forming apparatus of claim 6, wherein the prescribed image forming condition is the number of recording sheets to be output for a single job.

9. The image forming apparatus of claim 1, wherein the parallel processing represents that while a preset number of image formation for one job onto recording materials is conducted, image formation for the other job is carried out without waiting for a completion of the preset number of image formation for the one job.
